(19) United States
(12) Patent Application Publication
(10) Pub. No.: US 2014/0282581 A1
(43) Pub. Date: Sep. 18, 2014

(54) METHOD AND APPARATUS FOR PROVIDING A COMPONENT BLOCK ARCHITECTURE

(71) Applicant: MCKESSON FINANCIAL HOLDINGS, Hamilton (BM)

(72) Inventor: Mallik Vonteddu, Fremont, CA (US)

(73) Assignee: MCKESSON FINANCIAL HOLDINGS, Hamilton (BM)

(21) Appl. No.: 13/835,927

(22) Filed: Mar. 15, 2013

(51) Int. Cl. G06F 9/50

(52) U.S. Cl. CPC G06F 9/50
USPC 718/104

(57) ABSTRACT

A method, apparatus and computer program product are therefore provided in order to provide a component block architecture for allocation of resources in a data center environment. In this regard, the method, apparatus, and computer program product may identify a set of block attributes for a particular block of one or more applications, and compare the attributes to the available resources of a container. The component block may be allocated to the container based on whether the resources of the container are sufficient to meet the requirements of the component block.

### TECHNOLOGICAL FIELD

An example embodiment of the present invention relates generally to a scalable service architecture, and, more particularly, to a method and apparatus for allocation of resources in a data center environment.

### BACKGROUND

Recent trends in technology have shifted software applications away from traditional client-centric execution models. It is increasingly common for applications to be provided via “Software As A Service” (SaaS) models, where the primary responsibility for application execution is handled by remote servers located in large data centers. As more and more applications are provided via SaaS models, there has been an increase in demand for these data centers.

Traditional data center models may provide server hardware for execution of various programs. These data centers may include multiple server farms, including rack mounted server equipment, power sources, cabling, and other hardware. Traditional computing architecture models typically apportion these sets of hardware into discrete computing nodes, which are separately accessible and addressable within the data center. Applications are typically arbitrarily assigned to hardware within the data center, and reassigned to more powerful hardware if the need arises. However, these general purpose data centers may not be appropriate for all applications. For example, healthcare applications may possess unique requirements for availability, scalability, latency, privacy, security, and the like. General purpose data centers may not be able to provide service level agreements (SLAs) to customers that meet these needs. Current platforms for providing service hosting are inadequate for ensuring that a given data center will be able to meet the needs of a customer with such stringent requirements.

### BRIEF SUMMARY

A method, apparatus and computer program product are therefore provided according to an example embodiment of the present invention in order to provide a component block architecture for allocation of resources in a data center environment. In this regard, the method, apparatus, and computer program product of an example embodiment may identify a set of block attributes for a particular block of one or more applications, and compare the attributes to the available resources of a container. The component block may be allocated to the container based on whether the resources of the container are sufficient to meet the requirements of the component block.

Embodiments may provide a method for implementing a component block architecture. The method may include determining, using a processor, a set of component block attributes for a first component block. The first component block may include at least one software element. The set of component block attributes may define a set of performance requirements for the at least one software element. The method may further include determining a set of available resources for a container. The container may define an execution environment for at least one component block. The set of available resources may define resources available to the at least one component block during execution of the at least one component block. The method may also include determining whether the set of available resources meet or exceed the performance requirements specified in the set of component block attributes, and, in response to determining that the set of available resources meet or exceed the performance requirements, allocating the first component block to the container for execution by the container.

Embodiments may further include an apparatus comprising processing circuitry. The processing circuitry may be configured to determine a set of component block attributes for a first component block. The first component block may include at least one software element. The set of component block attributes may define a set of performance requirements for the at least one software element. The processing circuitry may be further configured to determine a set of available resources for a container. The container may define an execution environment for at least one component block. The set of available resources may define resources available to the at least one component block during execution of the at least one component block. The processing circuitry may be further configured to determine whether the set of available resources meet or exceed the performance requirements specified in the set of component block attributes, and, in response to determining that the set of available resources meet or exceed the performance requirements, allocate the first component block to the container for execution by the container.

Embodiments may also include a computer program product comprising at least one computer-readable storage medium bearing computer program instructions embodied therein for use with a computer. The computer program instructions may include program instructions configured to determine a set of component block attributes for a first component block. The first component block may include at least one software element. The set of component block attributes may define a set of performance requirements for the at least one software element. The program instructions may be further configured to determine a set of available resources for a container. The container may define an execution environment for at least one component block. The set of available resources may define resources available to the at least one component block during execution of the at least one component block. The program instructions may be further configured to determine whether the set of available resources meet or exceed the performance requirements specified in the set of component block attributes, and, in response to determining that the set of available resources meet or exceed the performance requirements, allocate the first component block to the container for execution by the container.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention;

FIG. 2 is a block diagram of an example component block architecture in accordance with an example embodiment of the present invention;

FIG. 3 is a flow diagram of an example method for allocating component blocks to containers in accordance with an example embodiment of the present invention;

FIG. 4 is a flow diagram of an example method for allocating a plurality of component blocks in accordance with an example embodiment of the present invention; and

FIG. 5 is a flow diagram of an example method for defining a component block in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided in accordance with an example embodiment of the present invention in order to provide a component block architecture. In this regard, a method, apparatus and computer program product of an example embodiment may determine a set of component block attributes for a component block comprising software for execution in a data environment. The component block attributes may enumerate resources that are required by the software associated with the component block. Containers within a data center environment (e.g., server racks, sets of server racks, individual servers, or the like) may be associated with certain resources. Component blocks may be assigned to particular containers based on the component block attributes for the component block and the available resources for the container. In this manner, aspects of the invention ensure that component blocks assigned to particular containers are allocated sufficient resources to satisfy performance, latency, and other requirements associated with the component blocks.

FIG. 1 illustrates a block diagram of an apparatus 102 in accordance with some example embodiments. The apparatus 102 may be any computing device capable of executing or allocating software execution according to a component block architecture as described herein. For example, the apparatus 102 may be implemented on a computing device within a data center environment, and/or used for configuring a data center environment. The apparatus 102 may be operable to determine a set of resources that the component block requires, and to assign the component block to a particular container based on the required resources. In some embodiments, the apparatus 102 may be a container in a data center environment, or at least a portion of a container in a data center environment. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 102 is implemented on a server, aspects of the user interface 116 may be limited, or the user interface 116 may even be eliminated. For example, the apparatus 102 may act as a server or host device, with a user interface provided by a client application.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

FIG. 2 is a block diagram of an example component block architecture 200 in accordance with an example embodiment of the present invention. The component block architecture 200 illustrates how an unallocated component block 201 may be allocated to a container according to example embodiments of the present invention.

The component block architecture 200 provides a modular, scalable infrastructure that ensures that applications within the system are provided with adequate resources to meet particular needs for reliability, scalability, performance, latency, and the like. To this end, the component block architecture 200 provides the ability to apportion software applications or sets of applications into “component blocks”. Each component block may include a set of component block attributes that indicate the requirements for execution of that particular component block. The block attributes may generally include maximum thresholds (or minimum hardware requirements) that the elements of the component can sustain. These block attributes may be entered into a monitoring system for proactive advice related to performance, capacity, and instructions for remediating any issues related to the component during run time. The component block may include a monitoring application that shows the status of the component block relative to the attributes of the component block to assist with determination of whether and when it is appropriate to consider allocation of a new component block for the particular application or service.

For example, component block attributes may include hardware or processing requirements, such as a minimum processor speed or a minimum amount of system memory, or the attributes may include particular redundancy requirements (e.g., application requires at least a Redundant Array of Independent Disks (RAID) 5 storage system), particular network requirements (e.g., application must be provided behind a load balancer), performance requirements (e.g., a maximum latency), or the like. The attributes may relate to a maximum requirement for the particular component block. For example, a component block may have an attribute indicating a maximum of 75 simultaneous connections for the component block, even if the average number of connections expected is lower, such as 25 connections. In the event support for more than 75 simultaneous connections is required, it may be necessary to allocate another component block of the same or a similar type. In this manner, the component architecture 200 may provide a scalable system by adding more component blocks as a given service scales to provide for additional users, application instances, network bandwidth or the like. In the present example, the component block architecture 200 includes an unallocated component block 201. For example, the unallocated component block 201 may relate to a particular service to be hosted in a data center. In the present example, the unallocated component block 201 is associated with a set of component block attributes 206. These component block attributes 206 indicate that the unallocated component block 201 may require up to 100 simultaneous connections, 4 gigabytes (GB) of system memory, and that the applications contained within the unallocated component block 201 may utilize up to 6 processor cores. As such, in order to prevent degradation of performance, the unallocated component block 201 may be assigned to a container that can provide at least 100 simultaneous connections, that has at least 4 GB of system memory free, and that can provide a multicore processor of up to 6 cores.

Each component block may further include a set of block instructions 208. The block instructions 208 may include installation and configuration instructions necessary to execute the component block using a container. For example, the block instructions 208 may include a set of installers, configuration scripts, and the like to copy necessary files and configure container resources to execute the applications contained within the component block. The block instructions 208 may provide for manual, partially automated, or fully automated installation of the block, depending upon the particular block and the capabilities of the block software and the container to which the block is allocated.

In the present example, the component block architecture 200 includes two containers, a first container 202 and a second container 204. Containers may represent a particular rack, group of racks, or any other group of computing nodes in a data center. In some embodiments, the container may represent the entire data center. Containers may be dynamically assigned or created within the data center as resources are used. For example, if a new component block is to be allocated but no containers have free resources to accept the component block, then a new container may be created or allocated to unallocated hardware within the data center. In the present example, each of the first container 202 and the second container 204 is represented as having a single processor and system memory for the sake of simplicity, but it should be readily apparent that a container may include multiple computing nodes, processors, memories, or the like. In this manner, a given container may include one or more apparatuses, such as the apparatus 102 described above with respect to FIG. 1. The containers may further include hardware and software to maintain the component block architecture and to facilitate the creation, allocation, and execution of component blocks, although in some embodiments these functions may be performed by a separate computing node other than the containers themselves.

Each container includes a set of container resources 210, 232, a resource status 212, 234, and a set of component blocks. The container resources 210, 232 provide an enumeration of the capabilities of the components (e.g., hardware, software, and combinations thereof) of each container. For example, the container resources 210 may indicate that the container has a particular amount of system memory, that one or more processors associated with the container is of a particular speed, that the one or more processors have a particular number of execution cores, that the container is connected to a load balancer, that the container has a particular amount of network bandwidth, that the container can support a particular number of connections, various performance capacities and thresholds (e.g., the container is capable of sustaining a particular performance level for a particular amount of time, but no longer), or the like.

Each of the containers 202, 204 may also include a resource status 212, 234 for the container. The resource status 212, 234 for the container may provide an indication for how many of the container resources are allocated to component blocks allocated to the container 202, 204. As such, the resource status 212, 234 may also serve to indicate the remaining resources free for the particular container 202, 204. These remaining resources may be compared against required resources for an unallocated component block prior to block allocation to determine if sufficient resources remain to support the allocation of the unallocated component block to the particular container.

Each of the containers 202, 204 may have component blocks allocated to the container. For example, the container 202 has the component blocks 214, 216, 218 allocated, and the container 204 has the component blocks 224, 226, 228 allocated. Allocation of a component block may include assigning the applications of the component block to execute on the particular container to which the component block is allocated. Execution of the component block may include following the block instructions, such as executing a set of scripts associated with the component block to configure the component block to execute on the particular container.

In the instant architecture 200, the first container 202 can support a maximum of 500 simultaneous connections, and the component blocks 214, 216, 218 allocated to the container may use up to a maximum of 475 simultaneous connections. The first container 202 may also allocate up to 32 GB of memory to component blocks, and the component blocks 214, 216, 218 allocated to the first container may utilize up to 24 GB of memory. The resource status 212 may also indicate the status of additional characteristics of the container, such as the fact that the first container 202 has a processor with 6 cores. As such, the resource status 212 for the first container 202 indicates that the container can support additional component blocks that require no more than 25 simultaneous connections and 8 GB of memory. Therefore, although the first container 202 has sufficient memory to support the unallocated component block 201, the first container 202 lacks sufficient additional simultaneous connections to support the unallocated component block 201, so the unallocated component block 201 would not be allocated to the first container. Although the instant example relates to a number of simultaneous connections and memory allocation, various other container resources and component block attributes may also be used to determine whether a particular block may be allocated to a particular container, and these specific examples should not be interpreted to be limiting.

FIG. 3 is a flow diagram of an example method 300 for allocating component blocks to containers in accordance with an example embodiment of the present invention. As described above with respect to FIG. 2, component blocks may be allocated to particular containers. Allocation of a component block may relate to assigning software associated with the component block to the particular container (e.g. a rack in a data center) for execution, such that the software associated with the component block executes on hardware assigned to the container. The allocation process may include determining the resource requirements of the component block (e.g., the component block attributes 206 as described above with respect to FIG. 2), and associating the component block with a container that can support the resource requirements of the component block. In some embodiments, multiple containers may be analyzed to determine which, if any, of the containers can support the requirements of the component block. The method 300 may be performed by a computer within or external to the data center, such as an apparatus 102 as described above with respect to FIG. 1.

At action 302, a set of component block attributes are determined for a component block, such as the unallocated component block 201 described with respect to FIG. 1. Although the instant example is described with respect to an unallocated component block, it should be readily appreciated that a component block may be reallocated after being previously allocated to a particular container. Component blocks may be identified for allocation in response to another component block being unable to meet the needs of the system. For example, a given component block may be identified as supporting up to 50 simultaneous user connections. If more than 50 simultaneous users attempt to connect to the given component block, a performance degradation may occur, causing an increase to latency or causing additional user connections to be requested. The system may detect that the given component block is insufficient to meet the demands of the system, and in response to this detection, create a new component block for the same service provided by the given component block. Additionally or alternatively, component blocks may be identified for allocation during a planning process prior to allocation of the component blocks. For example, a system administrator may identify which and how many component blocks will be necessary to meet the needs of customers of the system, such as based on SLAs entered between the data center owner and their customers.

Component block attributes may be determined prior to allocation, or the allocation process may include determination of the resource requirements of the component block. For example, attributes for a component block may be determined during definition of the component block. These component block attributes may be determined based on the collective resource requirements of software that is included within the component block. For example, developers or network administrators may identify particular resource requirements for the component blocks, or an automated process may test the component blocks to determine attributes for association with the component block. In some embodiments, attributes for a component block may be determined via a particular testing methodology or procedure. An example of a method for defining a component block is described further below with respect to FIG. 5.

At action 304, a container is selected. As described above, a data center may include a plurality of containers to which component blocks may be allocated. These containers may include processing hardware that is operable to serve as a host for execution of component blocks. At action 306, the selected container is examined to determine the container's available resources. As described above, the component block architecture may require that the container has sufficient available resources to accommodate the component block attributes before the component block may be allocated to the container.

At action 308, a determination is made as to whether the selected container has sufficient available resources to accept the component block. For example, the resource status of the selected container may be compared with the component block attributes to determine whether the selected container has sufficient free resources to enable the component block to execute without a performance degradation. In some embodiments, a determination may be made as to whether the particular hardware associated with the container is sufficient for the component block (e.g., a minimum number of processor cores) or whether the container has specific capabilities (e.g., a load balancer, a read-only file system) required for the component block, as well. If the container meets the requirements of the component block, the method proceeds to action 310. Otherwise, the method returns to action 304 where a new container is selected. At action 310, the component block may be allocated to the container which contained sufficient resources to accommodate the attributes of the component block.

At action 304, a new container is selected and the method may repeat the process of determining whether the newly selected container can accommodate the component block. In some embodiments, the method may iterate through each container within the system to identify an optimal container for allocation. An optimal container may be determined in a variety of ways. For example, the optimal container may be the container that has the smallest level of resource availability that can still accommodate the component block, or the optimal container may be the container that has the least overall resource allocation. One of ordinary skill in the art could recognize a variety of ways to optimize allocation of component blocks when presented with multiple containers from which to select. In some embodiments, selection of a container may also include instantiating a new container. For example, in circumstances where only a single container has been created, but the data center contains additional processing hardware that has not been associated with a container, the method may select a new set of hardware for creation of a container when additional resources are needed for execution of a component block.

A new container may be allocated where suitable hardware for creation of a new container exists, and any currently existing containers do not have sufficient resources to accommodate a new component block. In this manner, the system may provide an efficient, scalable architecture, because as performance needs for provided services increase (e.g., more users, more storage), more component blocks are allocated for those services. As more component blocks are allocated, the component blocks are assigned to containers until no container resources remain. When container resources are exhausted, new containers are created. As such, careful definition of the component attributes for each component block ensures that the services associated with the blocks always have sufficient resources to suit the needs of their customers. In some embodiments, particular services or customers may be associated with particular component block allocation requirements. For example, a given customer's SLA may include allocation for up to 500 users, and each component block for the customer's particular service may accommodate 50 users. As such, up to 10 component blocks for that particular service may be created for that particular customer. As another example, component blocks may have dependencies upon one another to provide a particular service or level of service to a user. For example, a first component block may depend on a second component block for interoperability. The customer's SLA may include a requirement that services should ensure communications between the first block and the second block are meeting certain defined response limits. To verify that communication is occurring according to these response limits, the resources allocated to the first block and the second block may be monitored to maintain a consistent performance so as not to exceed the response limits and thus deliver performance for those blocks according to the customer's SLA.

FIG. 4 is a flow diagram of an example method 400 for allocating a plurality of component blocks in accordance with an example embodiment of the present invention. As described above, a given data center may include a plurality of containers, each including one or more component blocks for execution using said containers. The method 400 provides the ability to manage component block allocations across the data center to ensure efficient allocation of data center resources and to ensure that the allocation meets the requirements of the allocated component blocks. The method 400 may be performed by a computer within or external to the data center, such as an apparatus 102 as described above with respect to FIG. 1.

At action 402, container resources are determined for one or more containers within the system. For example, available hardware and software resources for each rack or set of racks that make up the containers within the data center may be examined to determine the performance capabilities of each container. In some embodiments, each container may include a standardized set of hardware and software. For example, a container may include one or more separate computing nodes with a particular processor, memory, and storage configuration. Additionally or alternatively, a container may be associated with a particular set of performance requirements. For example, each container may require the ability to support a particular number of user connections or a particular number of processor cores, but the exact hardware to provide these requirements may not be specified.

At action 404, block attributes for component blocks that are to be assigned to the containers are determined. As described above, the component block attributes may be associated with the particular component blocks during creation or definition of the component blocks, such that each block is associated with a particular set of attributes specific to the software and/or services provided by the component block.

At action 406, the component blocks may be allocated to the containers based on the attributes of the component blocks and the available resources of the containers. In some embodiments, this optimization may occur automatically according to various optimization algorithms as described above with respect to FIG. 3. In some embodiments, the optimization may be performed by a user by assigning individual component blocks to particular containers. For example, a “drag and drop” interface may be provided allowing the user to drag component blocks to particular containers.

In some embodiments, the results of the optimization may be presented to a user for modification or confirmation. For example, the user may wish to alter the allocation provided by the system, or to add or remove component blocks from the allocation.

At action 408, the method 400 may validate the component block allocation. Validation of the component block allocation may determine whether the containers to which component blocks are allocated can support the resource requirements (e.g., the attributes) of the component blocks allocated to the containers. In some embodiments, validation may be performed dynamically as component blocks are assigned. For example, as the user allocates particular blocks to particular containers, the containers may be color-coded to identify if the attributes of the component blocks exceed the resources of the container (e.g., coloring a container red if the container cannot support the component block after allocation). As another example, the system may not allow allocation of a component block to a container if the attributes of the component block require more resources than the container has remaining, or if the component block requires particular resources or services the container does not have available (e.g., the component block requires a load balancer, but the container does not possess a load balancer). Upon validation of the allocations, the component blocks may be allocated to the containers identified by the method described above, and the component blocks may be executed on their assigned container according to instructions assigned for the particular component block, as described above with respect to FIG. 2.

FIG. 5 is a flow diagram of an example method 500 for defining a component block in accordance with an example embodiment of the present invention. As described above, component blocks may be associated with particular attributes that list the resource requirements for execution of the component block. These attributes may include a maximum set of resources that the component might use when under full load or at maximum capacity for any services included within the component block. For example, the attributes may define the most system memory the component block might consume, the maximum number of simultaneous users, and the like. These attributes may also include particular requirements for the component block not related to performance or capacity. For example, the attributes might indicate that the component block requires a load balancer, a RAID 5 storage array, or the like. Each component block may also be associated with a set of block instructions used to configure and execute the software and services included in the block on a container. The method 500 describes a process by which these attributes and instructions may be determined to define the component block for use in a component block architecture.

At action 502, the method 500 determines the software elements that will make up the component block. Each component block is associated with one or more software elements. For example, these software elements may include customer services (e.g., ordering applications, records access systems, or the like), support applications (e.g., web hosting applications, database applications, messaging middleware, or the like), or infrastructure elements (e.g., storage drivers, networking applications, or the like). In some embodiments, a given application may also require the presence of additional blocks in the system. For example, a customer application for providing access to medical records may also require a database application component block to function properly, and the database application component block may require the presence of a storage driver component block. The individual elements of a particular component block may be defined by an administrator of the system to provide for an efficient, intuitive association between particular system requirements and particular application. At action 504, the performance requirements for the component block attributes are determined based on the software components selected for inclusion in the component block. The particular performance requirements may be determined based on the performance needs of individual software components of the block in aggregate. For example, the “worst-case” requirements for each software element of the component block may be aggregated to determine a possible “worst case” for the block as a whole. These worst case requirements may be associated with a particular number of users or other performance metric established for the component block. For example, a user defining the component block may indicate that the block should serve the needs of a maximum of 50 simultaneous connections. As such, the performance requirements for the block may be based on the performance requirements for supporting 50 simultaneous users. In some embodiments, the performance requirements may be determined automatically via a testing application that simulates different performance scenarios for the component block, while in other embodiments the performance requirements may be determined based on testing procedures established by the user according to a testing protocol developed for determining performance requirements for the component blocks.

Although software may be grouped into particular component blocks based on user preference, each component block may undergo a verification process to ensure the component block is compatible with the architecture and to determine the performance requirements for the component block. For example, prior to creation, a component block be subjected to verification and testing for several performance factors including but not limited to design testing, deployment testing, scalability testing, performance testing, capacity testing, and maintenance testing. Each component block may include thorough documentation, and the component blocks may be exposed to rigorous performance tests and failure test case scenarios. This testing assist with creation of standard operating procedures for maintaining the component block in proper functioning and future upgrades. As such, prior to finalizing the performance requirements and capacities of the component block, each component block may be subjected to rigorous benchmarking and analysis. In some embodiments, performance requirements for the component block may include validation testing that tests all the communication flows with which a component block interacts during the lifecycle of its execution. This validation testing may be performed in an automated manner via a testing application. This testing application may report errors for monitoring and troubleshooting purposes.

At action 506, particular infrastructure requirements for the component software are determined. The infrastructure requirements may relate to particular hardware or software that must be present on a particular container to enable execution of the software elements of the component block. For example, as described above, a given component block may require access to a read-only file system, a load balancer, or a RAID 5 storage array. Additionally or alternatively, the infrastructure requirements may specify particular privacy or data protection provisions (e.g., an indication that the component block will access data protected under the Health Insurance Portability and Accountability Act (HIPAA)), and that the container and any other component blocks must also conform to these provisions.

At action 508, instructions for installation and/or execution of the component block are determined. These instructions may include scripts, configuration files, or any other data for executing the software elements of the component block on one or more containers. These instructions may be dynamically determined based on the software elements selected for inclusion in the component block, or they may be manually created by a user defining the component block. These instructions may provide the ability to execute the software elements of the component block on an arbitrary container.

At action 510, the component block may be defined by creating a structure including the software elements, the instructions, and attributes derived from the performance and infrastructure requirements, which may be used to assign the component block to a particular container. Once the component block has been defined in this manner, new instances of the block may be automatically created as the requirements of the system increase (e.g., a need for more users, more storage, etc.). In this manner, the component block architecture provides an efficient, scalable solution for allocation of software services within a data center environment.

It will be understood that each element of the flowchart, and combinations of elements in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining, using a processor, a set of component block attributes for a first component block, the first component block comprising at least one software element, and the set of component block attributes defining a set of performance requirements for the at least one software element;
determining a set of available resources for a container, the container defining an execution environment for at least one component block, and the set of available resources defining resources available to the at least one component block during execution of the at least one component block;
determining whether the set of available resources meet or exceed the performance requirements specified in the set of component block attributes; and
in response to determining that the set of available resources meet or exceed the performance requirements, allocating the first component block to the container for execution by the container.

2. The method of claim 1, wherein the first component block is associated with a particular software service, and the method further comprises:
determining that the service associated with the first component block is operating above a threshold capacity; and
in response to determining that the service associated with the first component block is operating above the threshold capacity, allocating a second component block for the service.

3. The method of claim 1, wherein the performance requirements comprise at least one of a system resource utilization and a presence of a particular system element.

4. The method of claim 3, wherein the system resource utilization comprise at least one of a system memory status, a system processor speed, or a number of simultaneous connections.

5. The method of claim 3, wherein the particular system element comprises at least one of a load balancer or a redundant array of independent disks storage system.

6. The method of claim 1, wherein the performance requirements comprise an indication that the execution environment must comply with provisions of the Health Insurance Portability and Accountability Act.

7. The method of claim 1, wherein the first component block further comprises a set of component block instructions for executing the first component block in the container.

8. The method of claim 1, wherein the set of component block attributes are determined via an automated testing procedure.

9. The method of claim 1, wherein the set of component block attributes are determined when the first component block is defined.

10. The method of claim 1, wherein the set of component block attributes are defined according to a particular service level agreement (SLA) entered between a customer and a data center provider.

11. An apparatus comprising processing circuitry configured to:
determine a set of component block attributes for a first component block, the first component block comprising at least one software element, and the set of component block attributes defining a set of performance requirements for the at least one software element;
determine a set of available resources for a container, the container defining an execution environment for at least one component block, and the set of available resources defining resources available to the at least one component block during execution of the at least one component block;
determine whether the set of available resources meet or exceed the performance requirements specified in the set of component block attributes; and
in response to determining that the set of available resources meet or exceed the performance requirements, allocate the first component block to the container for execution by the container.

12. The apparatus of claim 11, wherein the first component block is associated with a particular software service, and the apparatus is further configured to:
determine that the service associated with the first component block is operating above a threshold capacity; and
in response to determining that the service associated with the first component block is operating above the threshold capacity, allocate a second component block for the service.

13. The apparatus of claim 11, wherein the performance requirements comprise at least one of a system resource utilization and a presence of a particular system element.

14. The apparatus of claim 13, wherein the system resource utilization comprise at least one of a system memory status, a system processor speed, or a number of simultaneous connections.

15. The apparatus of claim 11, wherein the performance requirements comprise an indication that the execution environment must comply with provisions of the Health Insurance Portability and Accountability Act.

16. A computer program product comprising at least one computer-readable storage medium bearing computer program instructions embodied therein for use with a computer, the computer program instructions comprising program instructions configured to:
determine a set of component block attributes for a first component block, the first component block comprising at least one software element, and the set of component block attributes defining a set of performance requirements for the at least one software element;
determine a set of available resources for a container, the container defining an execution environment for at least one component block, and the set of available resources defining resources available to the at least one component block during execution of the at least one component block;
determine whether the set of available resources meet or exceed the performance requirements specified in the set of component block attributes; and
in response to determining that the set of available resources meet or exceed the performance requirements, allocate the first component block to the container for execution by the container.

17. The computer program product 16, wherein the first component block is associated with a particular software service, and the computer program product further comprises program instructions configured to:
determine that the service associated with the first component block is operating above a threshold capacity; and
in response to determining that the service associated with the first component block is operating above the threshold capacity, allocate a second component block for the service.

18. The computer program product of claim 16, wherein the performance requirements comprise at least one of a system resource utilization and a presence of a particular system element.

19. The computer program product of claim 18, wherein the system resource utilization comprise at least one of a system memory status, a system processor speed, or a number of simultaneous connections.

20. The computer program product of claim 16, wherein the performance requirements comprise an indication that the execution environment must comply with provisions of the Health Insurance Portability and Accountability Act.
